(19) United States
(12) Patent Application Publication
(10) Pub. No.: US 2026/0237193 A1
(43) Pub. Date: Aug. 13, 2026

(54) VISUAL MEMORY IN AUTONOMOUS AGENTS

(71) Applicant: SOUL MACHINES LIMITED, Auckland (NZ)

(72) Inventors: Josephine Jefferson, Auckland (NZ); Mark Sagar, Auckland (NZ); Nathan Pages, Auckland (NZ); Jonathan Conder, Auckland (NZ); Alireza Nejati, Auckland (NZ)

(21) Appl. No.: 19/469,414

(22) PCT Filed: Apr. 2, 2024
(86) PCT No.: PCT/IB2024/053163

§ 371 Date: Sep. 26, 2025

(30) Foreign Application Priority Data
Mar. 31, 2023 (NZ) 798767

(51) Int. Cl. G06V 10/774; G06V 10/46; G06V 10/75; G06V 10/764

(52) U.S. Cl. CPC G06V 10/774; G06V 10/464; G06V 10/751; G06V 10/764

(57) ABSTRACT

Embodiments described herein provide a method for autonomous agents (which may be situated, embodied agents) to learn new visual objects, and recognize the same objects within the same “runtime”/session/interaction, and be able to train a longer-term visual memory model on the object. A visual memory system stores templates of objects and compares images to these templates. An internal or external (to the agent) signal may determine which object/s to compare. The visual memory system stores new and unrecognized objects as “templates” and returns whether or not any region of the image is likely to contain a match for any of the stored templates. There is thus provided one-shot visual learning.

### TECHNICAL FIELD

Embodiments of the invention relate to computer vision, and situated, embodied computational agents. More particularly but not exclusively, embodiments of the invention relate to Visual memory in autonomous agents.

### BACKGROUND ART

Deep neural networks, for example Convolutional neural networks (CNNs) and visual transformers, have been used in computer vision tasks. CNNs are a popular class of deep learning models that have been shown to be highly effective at object recognition and classification tasks. These models are designed to mimic the architecture of the “what” pathway by using layers of neurons that process increasingly complex visual features.

Object detection models are trained on certain classes of objects, but may not be able to recognize and accurately classify all objects presented to it. It may be desirable for interactive embodied virtual agents to intelligently interact with new objects that are not recognized, learn about the new objects and/or consolidate its learning of new objects in an efficient and appropriate manner. Whilst some methods of few/one-shot learning are proposed, these are trained or manually designed to pre-process input data to a form more suited for matching and retrieval.

Catastrophic forgetting refers to the phenomenon in which a neural network trained to perform multiple tasks loses the ability to accurately perform earlier tasks as it is trained to perform new tasks. This is a major challenge in artificial intelligence, as it limits the ability of machine learning models to learn continuously over time. As the model learns new tasks, the weights associated with earlier tasks are adjusted, which can cause the model to forget what it has learned previously. Attempts to address this have included rehearsal, regularization, parameter freezing, and using multiple models for different tasks.

The sequential learning problem refers to the challenge of training a machine learning model to learn from data that is presented in a sequential order. In sequential learning, the model must update its knowledge and make predictions as new data becomes available. The challenge is that the model must balance the knowledge it has learned from previous data with the new information it is receiving. This is because the distribution of data in a sequential learning problem can change over time, which can affect the model's performance.

There is a need for a new visual object detection system that addresses at least some of the limitations of the prior art.

### SUMMARY OF INVENTION

It is an object of the invention to improve Visual memory in autonomous agents, or to at least provide the public or industry with a useful choice. Improvements described herein may support one-shot visual learning in real time, enables real-time sequential learning and catastrophic forgetting, and provide improved performance, efficiency, and generalizability.

### BRIEF DESCRIPTION OF DRAWINGS

FIG. 1 shows a visual processing system

FIG. 2 shows an interface showing the results of an image matching algorithm

FIG. 3 shows three objects and corresponding heat maps on a visual scene.

FIG. 4 shows a first output of visual memory system; and

FIG. 5 shows a second output of the visual memory system.

### DESCRIPTION OF EMBODIMENTS

### Overview

Embodiments described herein provide a method for autonomous agents (which may be situated, embodied agents) to learn new visual objects, and recognize the same objects within the same “runtime”/session/interaction, and be able to train a longer-term visual memory model on the object. A visual memory system stores templates of objects and compares images to these templates. An internal or external (to the agent) signal may determine which object/s to compare. The visual memory system stores new and unrecognized objects as “templates” and returns whether or not any region of the image is likely to contain a match for any of the stored templates. There is thus provided one-shot visual learning.

An artificially intelligent agent, may therefore be shown an object only once, to store a template of the object, and later query the stored template to recognize the object in the future, including within the same instance of the artificially intelligent agent's running. This provides one shot visual learning on the fly, as a template image of any part of the scene may be cached only once. Using an image matching system, regions of future scenes that match the template are identified, enabling template images (or parts of the scene) to be identified in future images.

The scene is queried using a Image matching System, which enables reliable detection of the same object throughout different parts of the scene, which can be used to generate labelled data, and add “bounding region (e.g. bounding boxes)” to the scene, and send to a longer term memory storage system (e.g. an object detector) where it can be used to train visual models.

In an implementation of post-processing of the image segmentation, classifications are bundled into a vector of Classification types, which include the class name, bounding box, name ID, confidence, objectness, fovea score (overlap with fovea), and whether the classification was generated by the object detector or template matcher. Only classifications which reach certain confidence/objectness thresholds are included in the vector.

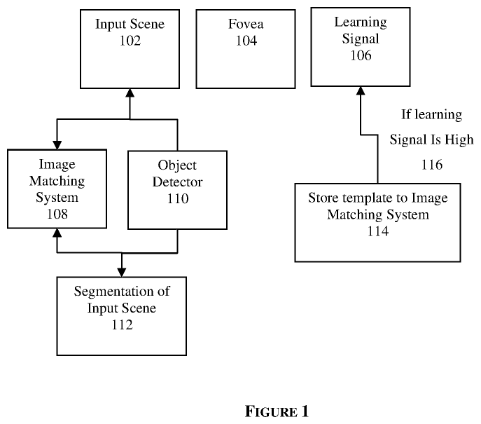

FIG. 1 shows visual memory system according to one embodiment. An Image matching system 108 and object detector 110 are used for segmentation 112 of the input scene 102. A Fovea 104 may represent an area of focus of an autonomous agent employing the visual memory system. A learning signal 106 may be provided to store new templates to the Image matching system 114 if the learning signal is high 116.

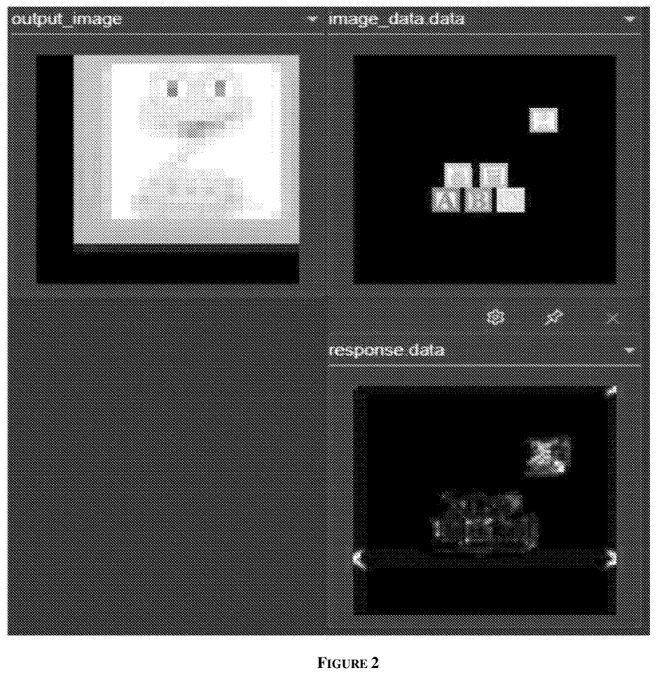

FIG. 2 shows an interface showing the results of an image matching algorithm. The top left box (output_image) shows a snake which is a template. An image matching algorithm compares top right image of blocks (image_data.data) to the template. The bottom right image (response.data) shows the output from the template matching algorithm, wherein lighter colour indicates a stronger match for the template matching algorithm. Note the area where a snake block matches the snake template in the block image appears much lighter, indicating the presence of the template object in that area.

FIG. 3 shows another interface showing the results of an image matching algorithm. Three templates 302 snake, 304 horse and 306 letter “A” are shown on the left. An image matching algorithm compares each template to the input scene 300. Three outputs 312, 314 and 316 shown on the right hand side correspond to each object template respectively. There is much less white on the output 314 for comparison with the horse template 304, as there is no good match for this template in the input scene 300. 312 shows the area where the snake appears in the input image 300 highlighted in white, and likewise 316 shows the area of the input scene where the “A” block 306 appears highlighted in white.

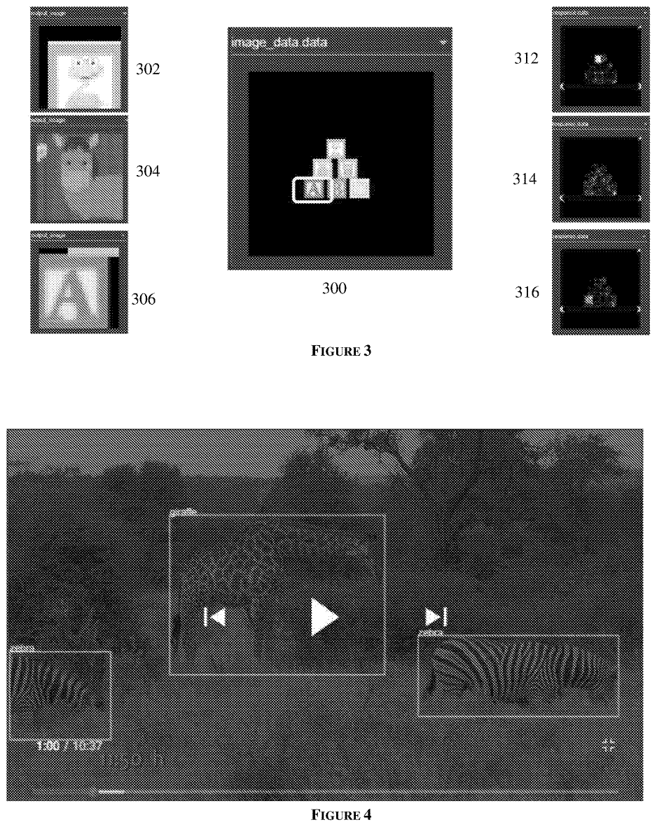

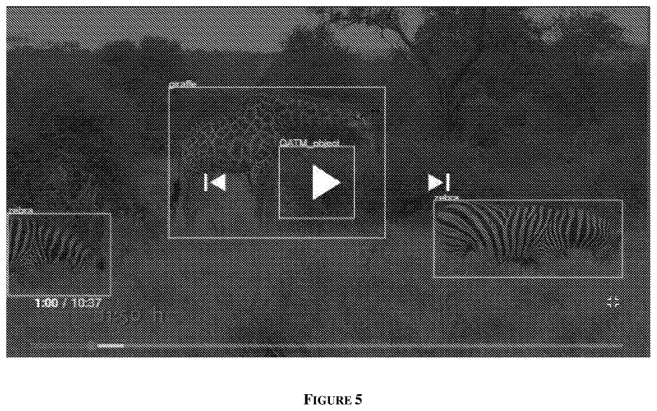

FIG. 4 shows a first output of visual memory system, with a zebra, a second zebra and a giraffe detected. Another object (namely a play button), in the visual stream of the autonomous agent is also present but not yet detected. FIG. 5 shows a second output of the visual memory system, wherein the play button identified and added to the image matching system (in this case, as a QATM object). The play button in the context of the remaining scene can now be added as training data to the trainable object detector.

An artificially intelligent agent can thus be driven using two vision systems operating in parallel namely an image matching system, which can learn and identify new objects on the fly (by finding which parts of an input image/scene match learned templates), as well as an object detector which may have been pretrained to identify a vast range of objects and can output all objects it recognizes continuously.

The object detector can then be trained to incorporate the new objects added to the image matching system, using training examples of the new objects captured in the artificially intelligent agent's visual stream.

### Image-Matching System

Image matching System performs one-shot visual learning. When a learn signal is received, that triggers inputs to be sent to the image matching system and the image is stored as a template.

### Inputs to Image Matching System

The image matching system may receive, as Input, on or more of:
An image of the entire scene. This may comprise everything in one or more “visual fields” of an embodied agent. In one embodiment, this is a camera stream. In other embodiments, this may be input from a digital user interface, computer application, or any other suitable input.
A bounding region (e.g. bounding box) (which may be generated by a Object Detector or “Fovea”). One or more bounding region (e.g. bounding boxes) may be created around detected objects. In one embodiment, a bounding region (e.g. bounding box) from all bounding region (e.g. bounding boxes) detected by the Object Detector on the scene is selected by a certain criterion. For example, the bounding region (e.g. bounding box) having the largest overlap with the fovea at the time of sending the image to the visual memory system is selected. A certain threshold of overlap between the fovea and a bounding region (e.g. bounding box) may be imposed before sending a selected bounding region (e.g. bounding box) to the visual system for further processing.
A Fovea location
an Object detection label

### Image-matching Heat-map Check: Returns Heat Map for Each Template.

Given an input being queried (e.g. the image of the entire scene), the image matching algorithm searches through stored templates to determine whether there are any matches with already-stored templates. When the image matching system is queried on a scene, for each stored template, a heat map is returned for each of the stored templates (images already stored in the image-matching system). In other words, the frame for inference is compared to each template, and a heat map is returned for each template. The heatmap may be passed through a box filter twice to identify heatmap “peaks.” The maximum intensity of the filtered heat map is taken as the confidence, and the position of that intensity is inferred to be the center of the object. To generate a bounding region (e.g. bounding box) for the image segmentation, the dimensions of the template image are used, and the bounding region (e.g. bounding box) is placed around the inferred center. The template ID is taken as the class label.

The whole scene image may be queried by a template matcher (for example QATM), for matches to any templates on the server. When the heat map is returned, the system checks the average saliency within the bounding region (e.g. bounding box) against the average saliency of the whole scene. If this ratio reaches a predefined template-match threshold, then the object is classified as a match to the template.

### Generate Outputs:

In one embodiment, the image matching system generates a class label, which is a unique identifier for the class of the object, from a set of unique identifies for each object in known by the Object Detector in addition to the objects stored in Image matching System.

In another embodiment, along the learning signal, a user (or otherwise) provides the class label, which is the unique identifier for the class of the object, which may be natural language representing the object class (e.g. cup, chair, person).

The image matching system may generate outputs (training examples) for future training or immediate use within the embodied agent's runtime. The following outputs may be generated, stored and used for training a Object Detector. The Object Detector may be trained during a consolidation stage:
Scene image
Input Bounding region (e.g. bounding box)
A Text label to be associated with the bounding region (e.g. bounding box), such as object_X where X=class label from Image Matching System.

### Fovea

An autonomous agent may include a simulation of a fovea-a region at which the embodied agent is attending to/looking at any given time. The fovea may be defined by a bounding region (e.g. bounding box). The vision processing system may be configured to return fovea bounding region (e.g. bounding box) so that the information of where the autonomous agent was looking can remain associated with image segmentation.

The overlap of each bounding region (e.g. bounding box) from image segmentation with the fovea bounding region (e.g. bounding box) is calculated. when the agent is looking at an object, the overlap calculation will return 1 when the object is fully within the fovea (even if it has a very small bounding box). The output of this overlap calculation is the “fovea score”. A fovea score is associated with each classification. This is used to determine if/what object is attended to by the fovea at any given time.

The autonomous agent or avatar may be associated with a field representing the object the agent is looking at (“Fovea class”). The fovea class is determined by the max fovea score (overlap with fovea) from among the classifications vector (uncertain classifications have already been filtered out). If the max fovea score is over a certain threshold, then that class is the fovea class, otherwise there is no fovea class (in other words, the system decides that the agent is not looking at an object. For example, the agent may be looking at a background or empty space.

### Output to Situations

The agent may have a representation of “Situations” namely a list of what is present in a scene and where it is. Image segmentation may provide output to situations in the form of the presence/absence of mapped objects in the scene, and the locations and centres of each of the mapped objects.

### Output to a Saliency Map

A salience map is a representation of the screen to an Agent in terms of importance. Salience maps may define where the attention and focus of an Agent is. Examples of features which may be differentially treated as salient or not include recognition of objects or images or subclasses of objects or images. The output from the visual processing system may be provided to a saliency map which biases or directs the attention/fovea of the autonomous agent based on any number of factors, thus providing ‘objects’ as a set of inputs which may increase the salience of regions in the scene. The “object saliency map” may highlight the scaled center locations of objects identified during segmentations as salient regions.

### Consolidation Process

The Image Matching system may be used to generate training data for a more general visual model, and integrate objects learned during operation of an interactive agent as objects in a Long Term Visual Memory (modelling consolidation).

For object detection training, a custom training process may use rehearsal to fine-tune on a new dataset. In each epoch, the training process trains on a random subset of data from its pretrained set and combines that with the whole set of new data. This is to avoid catastrophic forgetting of what it's previously learned, and to avoid the sequential learning problem. Any suitable consolidation process may be used.

Consolidation may be triggered in any suitable manner. For example, it can be triggered:
manually
each time a new object is seen,
after a “session” of a user interacting with the agent,
after a predetermined number of new objects are learned,
after a certain time period has elapsed

### Training Set for Consolidation

Even if an object is a second encountering of a new object in short term memory, it still becomes a training item the Object Detector [with the same label]. Furthermore, even objects which are already classifiable by the Object Detector (i.e. they have been already trained via a Object Detector) will become training data, if they occur in images which are already training data, so that the Object Detector continues to recognise these objects after consolidation.

### Consolidating While Running

Memory consolidation may be performed while the agent is “sleeping”, not running, or in a state whereby its visual memory system cannot be queried. In some embodiments, a duplication of the Object Detector may be made such that one version is trained while the other is queried, followed by a replacement of the model with the most up-to-date version.

### Integration with Runtime

Whether an object was trained by the image-matching system, or the or Object Detector, their integration with downstream identification of the object and features of the autonomous agents, such as memory mappings, situations, salience may be treated in an identical manner.

### Object Detector

Object detectors are models that are designed to detect objects. These models are known for their fast inference speed, making them suitable for real-time applications where speed is crucial. Examples include YOLO, SSD (Single Shot Detector), EfficientDet and YOLOX. Single-shot detectors have become a popular choice for real-time object detection applications, such as autonomous vehicles, video surveillance, and robotics, where fast inference speed is essential. Single-shot detectors divide an image into a grid of cells and predicting the location, class, and size of objects within each cell. This is typically achieved using anchor boxes, which are pre-defined bounding region (e.g. bounding boxes) of different sizes and aspect ratios that the model uses to predict the location and size of objects.

Given an scene (input frame), an Object Detector may return:
bounding region (e.g. bounding boxes) around identified objects.
an objectness score (how sure the Object Detector is that the bounding region (e.g. bounding box) actually contains an object).
a class label (what is in the bounding region (e.g. bounding box)).
a class confidence (how sure YOLOX is about the class).

The Object Detector may be restricted to return a maximum number of bounding region (e.g. bounding boxes) per frame (e.g. 10).

### YOLOX

In one embodiment, the Single-shot detector used in the visual memory system is YOLOX (You Only Look Once X). The YOLOX model is based on a single-shot detector architecture, meaning that it processes the entire image only once to detect objects in real-time. It achieves this by using a set of anchor boxes to predict object locations, scales, and aspect ratios. Additionally, YOLOX introduces several innovations that improve the accuracy and efficiency of object detection:

Decoupled Head: The head of the YOLOX model is decoupled from the backbone, allowing for more flexibility in model design and enabling the use of larger backbones for improved accuracy.

Cross-Stage Partial Network (CSPNet): This is a novel network architecture that uses a parallel partial network and a cross-stage fusion operation to improve information flow and feature reuse.

Scaled-YOLOX: This is a family of models with varying model sizes that can be scaled up or down to meet different performance requirements. This allows for a more efficient use of computing resources and enables YOLOX to perform well on a wide range of devices.

Adaptive Training Sample Selection (ATSS): This is a sampling method that selects training samples based on their difficulty and importance, improving the model's ability to handle small objects and dense scenes.

### Shared Core

In one embodiment, aspects of the image matching model and the object detection model may be combined. For example, a shared CNN core of the image matching model may be used for feature processing for the object detector.

### Image Matching System/Algorithm

Image matching algorithms are a class of computer vision algorithms that are used to find similarities or correspondences between two or more images. The goal of image matching is to determine whether two images contain the same object, scene, or pattern, and to estimate the transformation that relates them. There are several types of image matching algorithms, including feature-based matching, template matching, and deep learning-based matching.

Feature-based matching: matches keypoints or features between images based on their local appearance, such as edges, corners, or blobs. Examples of feature-based matching algorithms include SIFT (Scale-Invariant Feature Transform), SURF (Speeded Up Robust Features), and ORB (Oriented FAST and Rotated BRIEF).

Template matching: matches a predefined template or pattern with a region of an image to find occurrences of the template. Examples of image matching algorithms include NCC (Normalized Cross-Correlation) and QATM (Quality-Aware Image matching).

Deep learning-based matching uses convolutional neural networks (CNNs) to extract features from images and learns to match them in a supervised or unsupervised manner. Examples of deep learning-based matching algorithms include Siamese networks, which learn a similarity metric between pairs of images, and SuperPoint, which jointly detects keypoints and descriptors using a CNN.

### QATM

QATM (Quality-Aware Image matching) is designed to match images with different resolutions and aspect ratios by estimating the quality of the image regions and performing image matching on the highest quality regions. QATM works by first dividing the input images into non-overlapping blocks of different sizes. It then uses a quality estimator to assign a quality score to each block based on the local contrast and structure of the image. Blocks with high quality scores are considered to contain important image features and are used for image matching.

For each high-quality block, QATM performs image matching by sliding a template over the block and calculating a similarity score at each location. The location with the highest similarity score is considered the match for the template.

QATM also includes several optimizations to improve the accuracy and efficiency of image matching. For example, it uses a multi-scale approach to match templates of different sizes and includes a non-maximum suppression step to eliminate duplicate matches.

In the context of the present invention, an image-matching algorithm such as QATM may be used to perform one-shot learning of visual objects not recognized by the object detector. For the purpose of the visual memory system described herein, an image matching algorithm stores templates, which are later used to query the scene to determine if anything in the visual scene matches the stored templates. The image matching system may, given in input template, return a “heat map” of the scene or input image, returning the scene or image with regions differentially highlighted to different degrees/intensities, reflecting how closely the region matches the input template. In other words, this allows querying the location of potential template-matches within an image, as well as the strength of the potential match.

### Three-Dimensional Object Templates

Adaptions to the present invention may be made to enable the image matching algorithm to remember and recognize 3D objects at different orientations and scales, are required. For example, multiple templates may be stored for each template, and/or models of “spatiotemporal consistency” may be employed for enhanced image matching. For example, if object 1 is at a similar location at a similar time to object 2, they are likely to be the same object (especially if the object is being tracked)-the threshold for what is considered a “match” may be, for example, reduced in such contexts.

### Simultaneous Training of an Object Detector by Multiple Agents, Instances or Users

In one embodiment, a Memory Store may collect data from any number of instances of the autonomous agent running, and the data may be used to train one or more detection algorithms or trainable object detectors as described herein.

The memory store may be queried to retrieve certain subsets of data to train an object detection (or other visual processing algorithm) in a specific manner, for example, by user, by time of day, by context, or by any other suitable parameter/s. For example, to train on all objects people have interacted with, when buying cars.

The patent application WO2021005540A2 titled “MEMORY IN EMBODIED AGENTS” also owned by the present applicant, and incorporated by reference herein discloses how the output of the vision processing system may be stored to a Memory Database, which is populated from real-time experiences of the autonomous agent in the course of live operation of the autonomous agent (which may be interacting with a human user or computer system). The Memory Database which stores memories experienced by the autonomous agents, including metadata, or additional data about the Experiences stored in the memory database such as, a time the event took place (a timestamp), a GPS location of the event, or any other contextual information relating to the Experience. Further metadata stored by the Memory store may include data about the user, the version or the “agent” which is running, the instance which is running, context, or any other suitable metadata.

### Summary of System

The visual short term memory system stores templates of objects and compares images to these templates. The system stores new and unrecognised objects as templates, and determines whether objects being looked at match stored templates. This provides “one shot visual learning”: an embodied agent or avatar only has to be shown an object once (to store a template), then it can query stored templates to recognise the object in future.

Thus images used by the image matching system are able to be updated and used by the image matching system in real-time, while a user is interacting with the system, and later consolidate learning into an object detector, by training the object detector with objects identified by both the image matching system, and a pretrained object detector. Embodiments described herein enable sequential learning that is real-time and based on experience of an agentic AI system.

### Interpretation

The methods and systems described may be utilised on any suitable electronic computing system. According to the embodiments described below, an electronic computing system utilises the methodology of the invention using various modules and engines. The electronic computing system may include at least one processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the electronic computing system may include one or more communication devices (wired or wireless) for communicating with external and internal devices, and one or more input/output devices, such as a display, pointing device, keyboard or printing device. The processor is arranged to perform the steps of a program stored as program instructions within the memory device. The program instructions enable the various methods of performing the invention as described herein to be performed. The program instructions, may be developed or implemented using any suitable software programming language and toolkit, such as, for example, a C-based language and compiler. Further, the program instructions may be stored in any suitable manner such that they can be transferred to the memory device or read by the processor, such as, for example, being stored on a computer readable medium. The computer readable medium may be any suitable medium for tangibly storing the program instructions, such as, for example, solid state memory, magnetic tape, a compact disc (CD-ROM or CD-R/W), memory card, flash memory, optical disc, magnetic disc or any other suitable computer readable medium. The electronic computing system is arranged to be in communication with data storage systems or devices (for example, external data storage systems or devices) in order to retrieve the relevant data. It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines. It will be understood that the arrangement and construction of the modules or engines may be adapted accordingly depending on system and user requirements so that various functions may be performed by different modules or engines to those described herein, and that certain modules or engines may be combined into single modules or engines. It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using, any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device. The methods described herein may be implemented using a general-purpose computing system specifically programmed to perform the described steps. Alternatively, the methods described herein may be implemented using a specific electronic computer system such as a data sorting and visualisation computer, a database query computer, a graphical analysis computer, a data analysis computer, a manufacturing data analysis computer, a business intelligence computer, an artificial intelligence computer system etc., where the computer has been specifically adapted to perform the described steps on specific data captured from an environment associated with a particular field.

1. A computer-implemented method for training a trainable object detector from a visual stream, comprising:
i. adding one or more objects in the visual stream to an image matching system;
ii. generating one or more training examples from one or more frames from the visual stream including the one or more objects added to the image matching system; and
iii. using the one or more training examples to train the trainable object detector on the training examples.

2. The method of claim 1 wherein the image matching system is a template matching algorithm.

3. The method of claim 1 wherein the method includes the step of using a pretrained object detector to identify and classify pretrained objects appearing in the visual stream and the one or more training examples also includes the pretrained objects and classifications.

4. The method of claim 3 wherein the object detector is a single-shot object detector.

5. The method of claim 1 wherein the step of adding one or more objects in the visual stream to an image matching system is associated with an embodied agent directing its attention to the one or more objects.

6. A computer-implemented method for object detection, comprising:
i. receiving an input scene;
ii. identifying objects in the input scene using an object detection algorithm;
iii. identifying objects in the input scene using an image-matching algorithm, trained on objects identified in earlier frames of the input scene; and
iv. generating a representation of the image scene including objects identified using the object detection algorithm and the image-matching algorithm.

7. A method of driving visual attention of an embodied agent on an input scene, comprising: using the method of claim 6 to detect objects in the input scene and using the generated representation of the image scene in a salience map on the input scene to bias the attention of the embodied agent towards salient regions of the input scene.

8. (canceled)

9. A computer-readable medium comprising instructions which, when executed by a computer, cause the computer to:
i. add one or more objects in the visual stream to an image matching system;
ii. generate one or more training examples from one or more frames from the visual stream including the one or more objects added to the image matching system; and
iii. use the one or more training examples to train the trainable object detector on the training examples.

10. The computer-readable medium of claim 9 wherein the image matching system is a template matching algorithm.

11. The computer-readable medium of claim 9 wherein the method includes the step of using a pretrained object detector to identify and classify pretrained objects appearing in the visual stream and the one or more training examples also includes the pretrained objects and classifications.

12. The computer-readable medium of claim 11 wherein the object detector is a single-shot object detector.

13. The computer-readable medium of claim 9 wherein the step of adding one or more objects in the visual stream to an image matching system is associated with an embodied agent directing its attention to the one or more objects.

14. A computer-readable medium comprising instructions which, when executed by a computer, cause the computer to:
ii. identify objects in the input scene using an object detection algorithm;
iii. identify objects in the input scene using an image-matching algorithm, trained on objects identified in earlier frames of the input scene; and
iv. generate a representation of the image scene including objects identified using the object detection algorithm and the image-matching algorithm.

15. The computer-readable medium of claim 14, comprising further executing, by the computer, the instructions to drive visual attention of an embodied agent on an input scene by detecting objects in the input scene and using the generated representation of the image scene in a salience map on the input scene to bias the attention of the embodied agent towards salient regions of the input scene.
